(19) United States
(12) Patent Application Publication
(10) Pub. No.: US 2008/0212426 A1
(43) Pub. Date: Sep. 4, 2008

(54) Recording Apparatus Having a Media-and Temperature-Dependent Power Control Scheme

(75) Inventor: Tony Petrus Van Endert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,064

(22) PCT Filed: Feb. 17, 2005
(86) PCT No.: PCT/IB05/50591

§ 371 Date: Aug. 17, 2006

(30) Foreign Application Priority Data
Feb. 24, 2004 (EP) 04100715.4

(51) Int. Cl. G11B 7/00

(52) U.S. Cl. 369/47.53

(57) ABSTRACT

The present invention relates to a recording apparatus, a record carrier, and a method of controlling a radiation power used for recording data on a record carrier, wherein a write power control is performed on the basis of temperature and disc-dependent parameters to solve write performance problems, especially on dye media. To achieve this, a first control parameter indicating a variation of the radiation power due to a non-homogeneity of the record carrier is predicted as a function of a recording position, and a second control parameter indicating a temperature dependency of the radiation power is predicted based on a measured temperature. Thereby, accuracy of writing power control can be improved, especially in case of a jump between arbitrary recording positions.

The present invention relates to a recording apparatus and to a power control method for controlling a radiation power used during recording of data on a record carrier, and to a record carrier to which information can be written using said recording apparatus and power control method.

Conventionally, recordable optical discs break down into two general types: write-once discs, and erasable/rewritable discs. Furthermore, there are two methods for recording information onto write-once optical discs. According to a first recording method, a laser beam is projected onto the recording surface to melt the surface thereby to form pits thereon. According to a second recording method, a thin film of organic dye is used as a signal recording surface, wherein the reflection factor is altered by projecting the laser beam onto said surface thereby to form optically detectable marks thereon.

Write-once discs, such as for example CD-R and DVD+R discs, are provided with guides called pregrooves. These pregrooves wobble slightly in a radial direction of the disc around a central frequency. In the wobble of the pregrooves information is recorded with an FSK (Frequency Shift Keying) modulation. Such information may consist of, for example, recording time address information called ATIP (Absolute Time In Pregroove), or recording address information called ADIP (Address In Pregroove).

With such write-once discs, a recording power calibration process known as Optimum Power Control (OPC) is carried out in order to set the laser beam of a recording device at an optimum recording power. The recording surface of the optical disc includes a data area for recording a variety of data and a Power Calibration Area (PCA) for test recordings in order to set the laser beam to its optimum recording power. The PCA is in general provided at the innermost track of the disc, and is in turn composed of a test area and a count area. The setting of the optimum recording power at time of recording requires that the optimum recording power be set for each disc individually. This because disc recording characteristics differ from one manufacturer to the next. It follows that an inability to obtain the optimum recording power for a disc can lead to a sharp increase in post-recording error rate and jitter.

In addition to an Optimum Power Control (OPC), a running OPC (ROPC) mechanism, which is a hardware feature with high bandwidth, or a Walking OPC (WOPC) mechanism, which is a software feature with low bandwidth, may be conducted during information recording. ROPC is a process in which the recording power is continuously monitored and adjusted when necessary by comparing the intensity of the light reflected back from the pits (or marks) when the optimum recording power was set during the OPC process with the intensity of the light reflected from the pits (or marks) during information recording, and correcting the recording power as appropriate based on the results of the comparison. As a result, the ROPC mechanism can continuously adjust the laser recording power, even as information is recorded on the disc moving radially from the inner periphery toward the outer periphery of the disc and as the optimum recording power varies from the optimum recording power set during the OPC process.

In WOPC, a parameter β (which indicates asymmetry of the recorded pits or marks) is monitored to achieve continuous optimal write power. With this parameter, which is linear to power, the regulation direction can be determined. This is not possible when monitoring jitter or Bit Error Rate (or BLER) due to a quadratic relationship with respect to power. Therefore the parameter β will be measured in the already written parts at certain time moments when the write process will be (temporarily) stopped. These values will be compared with a certain target value of β, as a reference value, which is determined during the OPC procedure. The differences between both values will be translated to a certain power. This WOPC procedure is a software procedure and enables compensation of variations in radial direction.

However, discontinuous recording procedures, such as writing at the inside of the disc after writing at the outside of a disc, may lead to the following problems. Suppose that a complete DVD+R disc is written. At the end of recording, a file system area located at the inside of the disc has to be updated. Due to power updates by the WOPC mechanism, to compensate for example for temperature and disc variations during the recording process, the optimal power at the inside of the disc is unknown. This could result in a bad write performance during the writing of the updated file system area at the inside of the disc. Conventionally, this problem has been solved by initiating an OPC procedure before the update of the file system area. However, in case of a multi-session disc, with a lot of reserved tracks to fill in on different positions, this may cause problems, especially since the Power Calibration Area has a limited size thereby limiting the number of OPC procedures.

A further problem is faced if it is intended to write at the outside of the disc, especially in case of dye discs, after an OPC at the inside of the disc. Then, the power could be wrong due to a non-homogeneous disc. The same problem will arise after video recording during editing phase where some parts are temporarily written at the outside of the disc. Conventionally, this problem has been solved by executing an extra tilt calibration during an interruption of the recording, to improve margins as far as possible. This, however, leads to the disadvantage of increased recording time for recording on the disc.

Document US 2002/0001270 A1 describes a power control scheme for an optical disc recording apparatus for recording information onto a write-once or erasable optical disc, wherein a table of prerecorded correction curves consisting of recording power correction values corresponding to radial positions for each type of a variety of different optical discs is provided. At the beginning of a recording session, it is referred to the table of correction values, such that the writing of information at an arbitrary radial position on the disc during a multi-session recording process can proceed at optimum recording power throughout, unaffected by any warpage of the optical disc.

It is an object of the present invention to provide an improved power control scheme by means of which power setting can be improved even in cases of non-continuous recording without requiring additional space and recording time. This object is achieved by providing a recording apparatus as claimed in claim 1, a power control method as claimed in claim 10, and a record carrier as claimed in claim 11.

Accordingly, recording power accuracy can be improved by correcting the recording or writing power based on the predicted first and second control parameters. The first control parameter relates to the non-homogeneity of a record carrier with respect to the recording position, and the second control parameter relates to the temperature-dependent wavelength changes. Thereby, disc dependencies as well as system dependencies can be compensated for. This is especially advantageous for DVD+R discs or other dye media that may be very sensitive to wavelength changes.

The first prediction means may be arranged to predict the control parameter based on a learning mechanism. To achieve this, a memory means may be provided for storing a table of power values as a function of the recording position. With such a learning mechanism the influence of the disc on the recording power can be determined based on experience during an earlier recording, or during an initial learning process.

Additionally, the first prediction means may comprise approximation means for performing a regression operation based on values obtained from the learning mechanism. Then, coefficients obtained from the regression operation may be used for predicting the first control parameter. Thus, only the coefficients describing the approximation function can be stored, and the first control parameter can be calculated based on the underlying approximation function.

The second prediction means may be arranged to calculate the second control parameter based on a measured laser temperature supplied from a temperature sensor and predetermined control information indicating a normalized radiation power dependency with respect to a radiation wavelength. This provides the advantage that the temperature-dependent second control parameter can be readily determined or predicted based on a simple calculation operation using the predetermined control information and the measured temperature value. The term normalized means that the value of the radiation power dependency is related to a predetermined value, such as for example its maximum value, its minimum value, or its average value.

In a specific example, the predetermined control information may be stored on the record carrier, and may be read by corresponding reading means. Thereby, the predetermined control information can be directly provided on the record carrier so that it is not necessary to store a table of corresponding control information for various disc types in the recording apparatus. The power control information may be written to the record carrier as new or extra ADIP information.

The present invention will now be described on the basis of a preferred embodiment with reference to the accompanying drawings, in which:

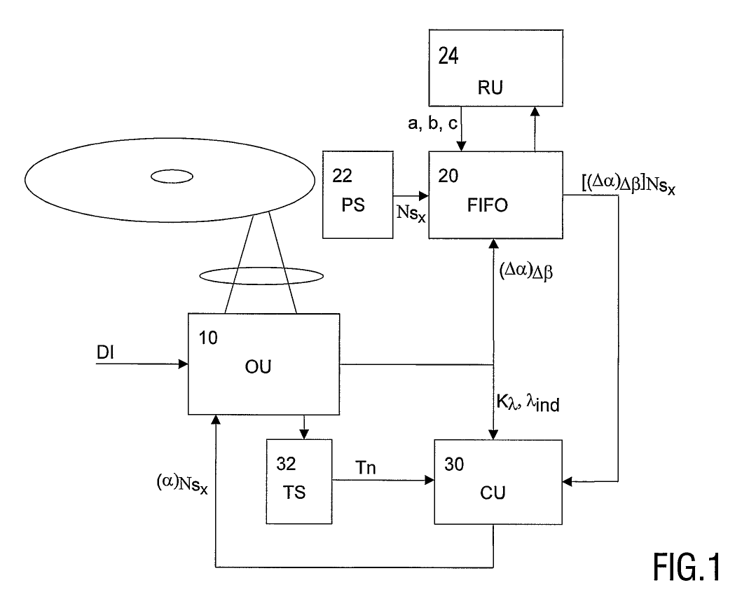

FIG. 1 shows a schematic block diagram of a recording apparatus according to the preferred embodiment; and

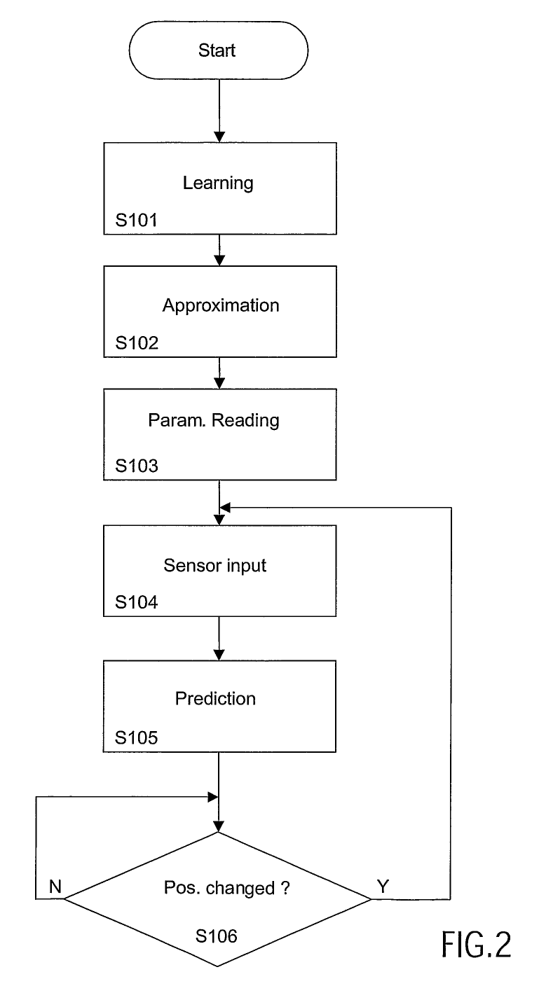

FIG. 2 shows a schematic flow diagram of a power control method according to the preferred embodiment.

In the following a preferred embodiment will be described with respect to an optical disc recorder for DVD+R discs. The DVD+R/+RW format is becoming increasingly popular for digital video recording as well as for all PC (Personal Computer) data storage applications. A key advantage of the DVD+R/+RW format over competitive formats is its backward compatibility with DVD read-only systems, allowing playback in existing DVD players.

FIG. 1 shows a schematic block diagram of an optical disc player according to a preferred embodiment of the invention. In FIG. 1, input data DI is supplied to an optical unit 10 in order to be recorded or written to the optical disc. On the optical disc a thin organic dye film is provided as a data storage layer. The recording principle is based on irreversibly modifying the dye's physical and chemical structure, induced by heating the dye with a focused radiation beam generated by the optical unit 10. The recorded marks (that is the areas where the dye has been modified) have optical properties different from their unmodified surroundings, giving read-out signals comparable to those obtained when reading read-only discs. The digital information is contained in the length of the recorded marks and the unmodified spaces between them.

It is to be noted that the block diagram of FIG. 1 only shows those parts of the recording apparatus that are involved in the power control procedure according to the present invention, while other components that might be necessary for performing the recording operation have been omitted for reasons of simplicity.

According to the preferred embodiment, parameters that influence power setting are predicted in respective predicting units, wherein the write power used by the optical unit 10 is corrected based on the predicted parameters. In particular, it is proposed to predict two parameters describing a system dependency causing a temperature-dependent wavelength change and a disc dependency due to non-homogeneities of the disc with respect to its radius. Thereby, write power accuracy can be improved, especially in case of wavelength-sensitive dye media. This prediction based control procedure is specifically advantageous in cases where a jump in recording is made from the outer diameter to the inner diameter of a disc, in which case a new OPC procedure would otherwise be needed which would take up additional disc space and recording time. In general, any recording on successive arbitrary positions can be improved since the laser power dependency can be modeled as a function of laser temperature and of disc properties.

As is shown in FIG. 1, the optical unit 10 is arranged to supply power variation values (Δα)_{Δβ} as a function of the recording position, that is the disc radius, to a memory, such as for example First-In-First-Out memory (FIFO) 20, to be used by a data learning mechanism. The storage in the FIFO table may be based on a position value Nsₓ obtained from a positional sensor. Furthermore, a regression unit 24 can be used for performing a regression operation using the stored power variation values in order to determine coefficients a, b and c describing an approximation function. Based on this approximation function a power control parameter [(Δα)_{Δβ}]_{Ns}_{ₓ} is calculated as a prediction result for the disc dependency of the power variation.

The optical unit 10 supplies a control parameter K_{λ} indicating a normalized laser power dependency with respect to the laser wavelength, and a wavelength parameter λ_{ind} indicating an indicative wavelength at an indicative power P_{ind} to a calculation unit 30. Both parameters are, for example, stored on the optical disc in the ADIP information and can be read by the optical unit 10. This information is pre-stored (by a disc manufacturer) in the pre-groove of the disc. Furthermore, a temperature sensor 32 is provided for sensing the laser temperature at the optical unit 10 and for supplying a measured temperature Tₙ to the calculation unit 30. Based on the disc-dependent control parameter [(Δα)_{Δβ}]_{Ns}_{ₓ}, the control parameters K_{λ} and λ_{ind}, and the measured temperature Tₙ, the calculation unit 30 first calculates a predicted temperature-dependent control parameter (Δα)_{Δλ} indicating a power variation due to a wavelength change, and then a final power control parameter (α)_{Ns}_{ₓ} corresponding to, or proportional to, the optimum recording power to be applied by the optical unit 10.

Hence, the power variations on the disc are divided into two parts, namely power variations due to wavelength changes and power variations due to non-homogenous disc properties. The influences of the temperature on the optimal write power can be predicted because the relationship between power and temperature (wavelength change) is a known function. As regards the power variations due to non-homogeneities of the disc, a sensitive parameter of dye discs is called β. This is a disc-dependent parameter which can be predicted by observing the power variation as a function of the disc radius or recording position, that is (Δα)_{Δβ}=f(Ns), wherein Ns denotes the disc radius. This observing is achieved by the learning mechanism at the FIFO memory 20. Thus, the power variations with respect to non-homogenous behavior of the disc as function of the radius is separated and stored for a certain media identity as a function of the disc radius.

Additionally, a write power versus wavelength determination is performed at the calculation unit 30 in an indirect way, namely by considering absorption versus wavelength. To achieve this, it is assumed that the recording power is inversely proportional to the absorption of the recording layer. Then, a translation from absorption versus wavelength to recording power versus wavelength can be made. The total prediction is thus based on the active learning mechanism at the FIFO memory 20 and the measured temperature at the temperature sensor 32.

For constant linear velocity (CLV) writing on dye discs an actual α value which is directly related to the recording power can be calculated for a radial position Nsₓ and at a certain temperature Tₙ based on the following equation (1):

(α)_{Ns}_{ₓ}=(α_{OPC})_{Topc}+(Δα)_{WOPC} (1)

wherein (α)_{Ns}_{ₓ} designates the actual α value, (α_{OPC})_{Topc} designates the α value of the recording power at the last OPC procedure at a temperature Topc, and (Δα)_{WOPC} designates a variation of the α value, and thus a power variation, at a WOPC procedure.

For a certain temperature, (Δα)_{WOPC} can be split up into two parts as defined in equation (2):

(Δα)_{WOPC}=(Δα)_{Δβ}+(Δα)_{Δλ} (2)

wherein (Δα)_{WOPC} is known and (Δα)_{Δλ}, which indicates the variation of the α value and thus the power variation due to a temperature change, can be calculated for the disc at a certain temperature Tₙ based on the following equation (3):

$${( Δα )}_{Δλ} = [ {K}_{t} \cdot ( {T}_{n} - {T}_{opc} ) \cdot \frac{{K}_{λ ( Nx )}}{{λ}_{ind}} ] \cdot {( {α}_{OPC} )}_{Topc} \qquad ( 3 )$$

wherein Kₜ designates a wavelength drift as a function of temperature (for example 0.22 m/° C.), Topc designates the laser temperature during the OPC procedure, and K_{λ(Nx)} designates a normalized laser power dependency with respect to wavelength. The power variation due to the non-homogenous disc at a certain recording position can be calculated using the following equation (4):

(Δα)_{Δβ}=(Δα)_{WOPC}−(Δα)_{Δλ} (4)

Finally, the required write power at a certain position and temperature can be calculated based on the following equation (5), which is based on a combination of equations (1) to (3):

$${P}_{W} ∼ {( α )}_{{Ns}_{x}} = [ 1 + {K}_{t} \cdot ( {T}_{n} - {T}_{opc} ) \cdot \frac{{K}_{λ ( Nx )}}{{λ}_{ind}} ] \cdot {( {α}_{OPC} )}_{Topc} + {[ {( Δ α )}_{Δ β} ]}_{{Ns}_{x}} \qquad ( 5 )$$

During the data learning mechanism, the variation of power due to the non-homogenous disc behavior (Δα)_{Δβ} is stored as a function of the disc radius Ns. When enough information is collected at the FIFO memory 20, this information will be reduced by using the regression unit 24. The regression performed by regression unit 24 is for example a second order polynomial regression. However, any other suitable type of regression may be used. The obtained coefficients a, b and c are then stored into the FIFO memory 20. Now, a determination of the disc-dependent control parameter [(Δα)_{Δβ}]_{Ns}_{ₓ} is possible. In an alternative embodiment of the invention the approximation by the regression unit 24 is dispensed with and the prediction of the disc-dependent control parameter may be based on the values obtained from the learning procedure as such.

It is noted that the calculation defined in the above equations (1) to (5) can be performed at the calculation unit 30, while the optical unit 10 is then controlled based on the recording or write power parameter determined as a result of equation (5).

FIG. 2 shows a flow diagram of a power control procedure according to a preferred embodiment. When the recording apparatus starts a new recording, a learning process is initiated in step S101 by means of which the FIFO memory 20 is loaded by corresponding power variation values. Next, in step S102, an (optional) approximation is performed in the regression unit 24 to obtain the coefficients approximated curve or function. Based on this approximated curve or function the disc-dependent control parameter is obtained or calculated in the FIFO memory 20 using the coefficients a, b and c.

In the next step S103, the parameters K_{λ} and λ_{ind} are read by the optical unit 10 and supplied to the calculating unit 30. Then, in step S104, the sensed or measured temperature value of the temperature sensor 32 is input to the calculation unit 30, and the calculation unit 30 performs a prediction of the optimum writing or recording power using the input parameters read from the disc, the sensed temperature value, and the predicted disc-dependent control parameter supplied from the FIFO memory 20 (step S105). Finally, it is checked in step S106 whether an arbitrary change of the recording position has occurred. If so, the procedure jumps back to step S104 in order to supply the possibly changed sensor input and disc-dependent prediction value to the calculation unit 30. Otherwise, if no arbitrary change of the recording position has occurred, the procedure remains in a waiting loop until an arbitrary change of the recording position occurs.

It is noted that the present invention is not restricted to the above described embodiment only, but can be used in any recording apparatus to achieve a combined compensation of disc-dependent and of temperature-dependent parameters influencing the writing power. In particular, the present invention is not restricted to optical disc media, but can be used for any recording media having the above properties. Moreover its is also suitable for CAV (constant angular velocity) writing procedures.

Furthermore, any type of control parameter suitable for predicting a required power variation due to temperature changes can be stored on the recording media or in the recording apparatus. Additionally, the prediction of the disc-dependent control parameter may be based on the values obtained from the learning procedure as such, and the approximation by the regression unit 24 may be dispensed with. The embodiments may thus vary within the scope of the attached claims.

1. Recording apparatus for recording data on a record carrier by irradiating said record carrier by a focused radiation beam having a radiation power, said apparatus comprising:
means (10) for generating said focused radiation beam;
first prediction means (20, 24) for predicting a first control parameter indicating a radiation power variation required to compensate for a non-homogeneity of said record carrier, as a function of a recording position;
second prediction means (30) for predicting a second control parameter indicating a temperature-dependency of said radiation power; and
power control means (10) for controlling said radiation power in dependence on said first and second control parameters.

2. An apparatus according to claim 1, wherein said first prediction means (20, 24) is arranged to predict said control parameter based on a learning mechanism.

3. An apparatus according to claim 2, wherein said first prediction means (20, 24) comprises a memory means (20) for storing a table of radiation power values as a function of said recording position.

4. An apparatus according to claim 2, wherein said first prediction means (20, 24) comprises approximation means (24) for performing a regression operation based on values obtained from said learning mechanism.

5. An apparatus according to claim 4, wherein said first prediction means (20, 24) is arranged to use coefficients obtained from said regression operation for predicting said first control parameter.

6. An apparatus according to claim 1, wherein said second prediction means (30) is arranged to calculate said second control parameter based on a measured laser temperature supply from a temperature sensor (32) and a predetermined control information indicating a normalized radiation power dependency with respect to a radiation wavelength.

7. An apparatus according to claim 6, further comprising reading means (10) for reading said predetermined control information from said record carrier.

8. An apparatus according to claim 1, further comprising calculation means (30) for calculating a laser power control value based on the following equation:
$${( α )}_{{Ns}_{x}} = [ 1 + {K}_{t} \cdot ( {T}_{n} - {T}_{opc} ) \cdot \frac{{K}_{λ ( Nx )}}{{λ}_{ind}} ] \cdot {( {α}_{OPC} )}_{Topc} + {[ {( Δ α )}_{Δ β} ]}_{{Ns}_{x}}$$

9. An apparatus according to claim 1, wherein said recording apparatus is an optical disc recorder.

10. A power control method for controlling a radiation power of a radiation beam used for recording data on a record carrier, said method comprising the steps of:
predicting a first control parameter indicating a radiation power variation required to compensate for a non-homogeneity of said record carrier, as a function of a recording position;
predicting a second control parameter indicating a temperature dependency of said radiation power; and
controlling said radiation power in dependence on said first and second control parameters.

11. A record carrier having a recording layer for recording data by irradiating the recording layer by a focused radiation beam having a radiation power, said record carrier comprising a control area storing a control parameter which indicates a required temperature dependency of said radiation power.

12. A record carrier as claimed in claim 11, wherein said control parameter indicates a normalized laser power dependency with respect to wavelength.

13. A record carrier as claimed in claim 11, wherein said control area comprises a pre-groove of said record carrier.
